(19) United States
(12) Patent Application Publication
(10) Pub. No.: US 2007/0090604 A1
(43) Pub. Date: Apr. 26, 2007

(54) Sealing device

(75) Inventors: Masanori Shibayama, Okayama (JP); Kazuo Ishii, Okayama (JP)

Correspondence Address: BACON & THOMAS, PLLC, 625 SLATERS LANE, FOURTH FLOOR, ALEXANDRIA, VA, 22314, US

(73) Assignee: Uchiyama Manufacturing Corp., Okayama (JP)

(21) Appl. No.: 11/581,419

(22) Filed: Oct. 17, 2006

(30) Foreign Application Priority Data
Oct. 17, 2005 (JP) 2005-301121

(51) Int. Cl. F16J 15/00

(52) U.S. Cl. 277/349

(57) ABSTRACT

A sealing device for sealing a space between two members relatively rotating in concentricity, comprising: a slinger fixedly fitted into one of the members, a core member fixedly fitted into the other of the members, and an elastic seal member attached to the core member, the elastic seal member having a seal lip elastically and slidably contacting with the slinger. The slinger has a fitting cylindrical portion to be fitted into the one member and a flange portion extending from the fitting cylindrical portion in its radial direction, whereas the seal lip has a base portion fixed to the core member and constitutes an axial lip elastically and slidably contacting with the inner surface of the flange portion of the slinger. The peripheral surface of the fitting cylindrical portion of the slinger and the corresponding peripheral surface of the base portion of the elastic seal member closely face each other with substantially constant space along the axial direction of the slinger, thereby constituting labyrinth construction between them.

### FIELD OF THE INVENTION

The present invention relates to a sealing device interposed into a necessary portion to be sealed between a stationary member and a rotating member like a bearing unit of a wheel suspension of vehicles, more particularly relates to a sealing device constructed such that a slinger is assembled with a core member for fixedly holding an elastic seal member which elastically and slidably contacts with the slinger.

### PRIOR ART

The above-mentioned sealing device is so called as a pack seal or a combination seal, a slinger and a core member for fixedly holding the elastic seal member are assembled to form a seal ring, and the resultant product is supplied to a customer. The prior arts JP-A-9-292032, JP-A-2003-314698, and JP-A-2005-524807 disclose such a sealing device. The sealing device is comprised of a slinger with an L-shaped cross-section which is fixedly fitted in one of two members rotating relatively and concentrically, a core member with an L-shaped cross-section which is fixedly fitted in the other member, and an elastic seal member which is provided with a seal lip elastically and slidably contacting with the slinger and is fixed to the core member, wherein the slinger and the core member, both having L-shaped sections, as assembled so as to face each other. The elastic seal member has, as a seal lip, a radial lip which elastically and slidably contacting with the peripheral surface of the cylindrical portion of the slinger while being assembled and an axial lip (side lip) which elastically and slidably contacts the inner surface of the flange portion.

According to the sealing device as constructed above, the radial lip elastically contacts with the peripheral surface of the fitting cylindrical portion of the slinger from the diametrical direction (radial direction), so that a large torque is loaded by the elastic contacting force when the rotatable member is rotated. Such torque considerably affects fuel cost and the like when the sealing devide is used for a bearing unit of vehicle wheels, therefore the improvement has been desired. A small gap (labyrinth) is formed between the peripheral edge of the flange portion of the slinger and the cylindrical portion of the core member (sometimes covered with an elastic seal member) so as to prevent incursion of outside waste water and dust. However, such incursion cannot be avoided with time, the entered dust is surrounded with the slinger and the core member to be piled up in the space divided with the axial lip. The piled dust is involved into the elastically and slidably contacting portion of the axial lip with the flange portion of the slinger to cause the axial lip worn away, thereby deteriorating the seal duration as a sealing device.

### SUMMARY OF THE INVENTION

The present invention is proposed in view of the above-mentioned problems and the object of the present invention is to provide a newly developed sealing device which allows the running torque to be reduced, the sealing ability to be superior and the seal duration to be long.

The present invention has the following effects.

When the sealing device of the present invention is used for the wheel bearing unit of vehicles, an axial lip and a flange portion of a slinger are elastically and slidably contacted, so that waste water and dust are prevented from being entered from outside into the sealed portion (bearing portion) and further lubricant (such as grease) charged in the sealed portion is prevented from leaking into outside. The labyrinth of a small gap extending into the length area along the axial direction is formed between a base portion of the axial lip and the peripheral surface of the fitting cylindrical portion of the slinger. Therefore, because of the labyrinth and the axial lip elastically and slidably contacting with the slinger, the lubricant is prevented from leaking outside. Further, the elastic seal member and the peripheral surface of the fitting cylindrical portion of the slinger do not contact each other and the radial lip does not present, therefore, the running loading torque applied to the rotatable member becomes small, thereby contributing energy efficiency of vehicles. The elastic and slidable contact of the axial lip and the flange portion of the slinger is into the axial direction (thrust direction), therefore, the running torque caused by the elastic and slidable contact does not become so large.

Further according to the present invention in which a plurality of axial lips are provided, the sealing ability like prevention of dust invasion and prevention of leakage of lubricant is more improved. Still further according to the present invention in which the outer lip provided at the elastic seal member elastically and slidably contacts with the outer surface of the tapered portion formed by bending the peripheral edge of the flange portion of the slinger, waste water and dust are prevented from entering from outside at the inlet portion of the space formed with the slinger, and the elastic seal member and the core member, so that they do not stay in the space. Therefore, it is prevented that the staying dust is involved into the elastically and slidably contacting portion of the axial lip and the flange portion of the slinger, so that the axial lip cannot be worn away and its sealing ability cannot be deteriorated.

Lack of mutual retention of the members (slinger, and elastic seal member/core member) without having a radial lip is compensated by the elastic contact of the outer lip and the tapered surface, thereby having a good assembling ability as a pack seal and preventing disassembling of the members. Further, the product can be packed while keeping the concentricity of the slinger, the elastic seal member and the core member to achieve a good management and conveying ability. Further according to the present invention, the member in which the slinger is fixedly fitted is a rotatable member and the member in which the elastic seal member and the core member are fixedly fitted is a stationary member, so that the sealing device can be used for a general purpose bearing unit, thereby obtaining more effect and improving usefulness.

### BRIEF DESCRIPTION OF THE DRAWINGS

FIG. 1 is a sectional view showing an example of bearing unit incorporated with the sealing device of one preferable embodiment of the present invention.

FIG. 2 is an enlarged view of the portion “X” in FIG. 1.

### DETAILED DESCRIPTION OF THE INVENTION

The preferred embodiment of the present invention is explained hereinafter referring to the attached drawings.

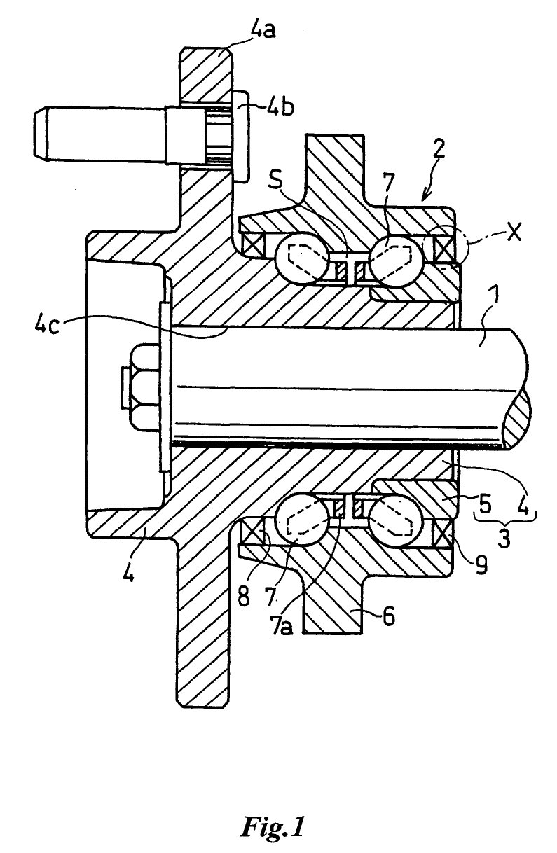

FIG. 1 shows one embodiment of the structure in which a vehicle wheel is supported for a driving shaft 1 with a ball bearing unit (hub bearing) 2. A tire wheel (not shown) is fixed to a hub flange 4a of a hub wheel 4 constituting an inner ring (rotatable member) 3 by means of a bolt 4b. The reference numeral 4c indicates a spline hole formed in the hub wheel 4 and the driving shaft 1 is spline fitted in the hole 4c and is integrally fixed to the hub wheel 4, thereby transmitting the rotating drive force of driving shaft 1 into the tire wheel via the hub wheel 4. The reference numeral 5 indicates an inner ring member, which constitutes the inner ring 3 together with the hub wheel 4.

The reference numeral 6 indicates an outer ring (stationary member) which is attached and fixed to the vehicle suspension (not shown) with bolts (not shown). Two rows of rolling elements (ball) 7 are interposed while being held with a retainer 7a between the outer ring 6 and the inner ring 3 (hub 4 and inner ring member 5). The reference numerals 8 and 9 indicate seal rings for preventing leakage of lubricant (grease and the like) charged in the rolling portion of the rolling elements 7 and for preventing incursion of waste water and dust from outside and they correspond to the sealing device of the present invention, and are inserted under pressure between the outer ring 6 and the inner ring 3. The space surrounded with the seal rings 8, 9 at both sides, the inner ring 3 and the outer ring 6 constitute a sealed portion S.

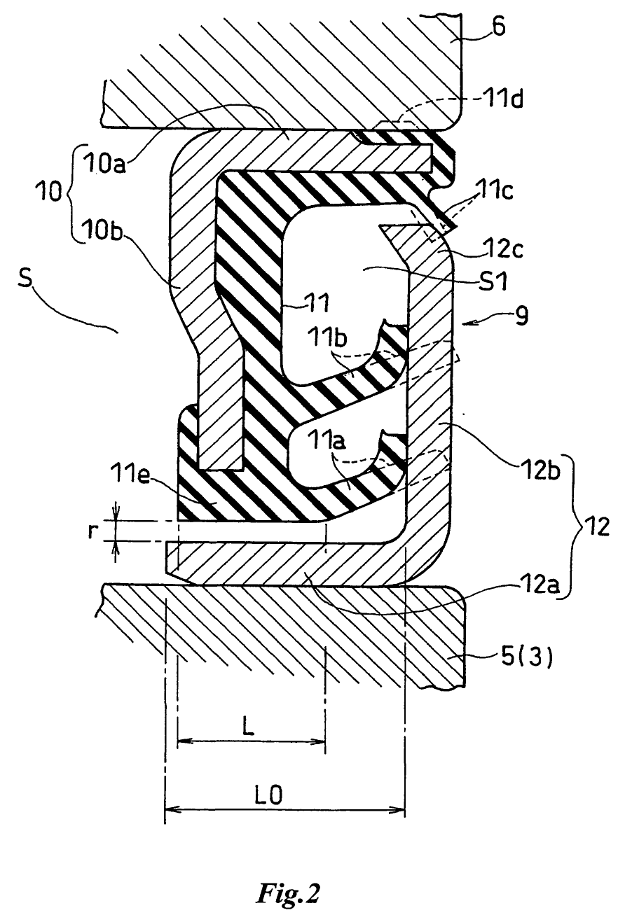

FIG. 2 shows an enlarged view of the part “X” in FIG. 1. The seal ring 9 at vehicle body side is constructed such that a ring-like core member 10 to be fitted under pressure in the inner circumference of the outer ring 6, an elastic seal member 11 made of an elastic material and fixed to the core member 10, and a slinger 12 externally fitted in the outer circumference of the inner ring member 5 are assembled to form a pack-seal type seal ring as shown in the figure. The slinger 12 comprises a fitting cylindrical portion 12a externally fixed in the outer circumference of the inner ring member 5 and an outward flange portion (flange-like portion) 12b extending at one end of the fitting cylindrical portion 12a outside (at the vehicle body side) of the sealed portion S into the radial direction (centrifugal direction). Further the slinger 12 has a tapered portion 12c formed by folding the outer peripheral edge of the outward flange portion 12b into the sealed portion S (fitting cylindrical portion 12a). The core member 10 comprises a fitting cylindrical portion 10a to be fitted in the inner circumference of the outer ring 6 under pressure and an inward flange portion 10b extended from one end at the sealed portion S side of the fitting cylindrical portion 10a into the diametrical direction (centripetal direction).

The slinger 12 and the core member 10 have an L-shaped section respectively and are assembled so as to face with each other. The elastic seal member 11 in the figure is made of a rubber material and is fixed and integrated to the inner surface from the end of the fitting cylindrical portion 10a to the end of the inward flange portion 10b of the core member 10 by vulcanizing adhesion. The elastic seal member 11 has two concentric axial lips 11a, 11b which are formed so as to elastically contact with the inner surface at the sealed portion S side of the outer flange portion 12b of the slinger 12, and has an outer lip 11c formed so as to elastically contact from outside with the tapered surface of the tapered portion 12c. Further, the elastic seal member 11 goes around the outer surface of the end of the fitting cylindrical portion 10a to be protruded as a rubber rolled portion 11d at the outer periphery of the wraparound portion.

The slinger 12 and the core member 10 having the elastic seal member 11 are assembled so as to face each L-shaped section. In such an assembled condition, the axial lips 11a, 11b and the outer lip 11c are elastically deformed from the position shown with dotted lines to the solid liens as shown in the figure, the axial lips 11a, 11b come to elastic contact with the inside facing the sealed portion S of the outward flange portion 12b of the slinger 12 and the outer lip 12c comes to elastic contact with the outer surface of the tapered portion 12c. In this case, the elastic contact force of outer lip 11c is applied to the slinger 12 as the force into the centripetal direction and the slinger 12 and the core metal 10 with the elastic seal member 11 achieve mutual retention by the applied force, thereby keeping a concentric and stable assembled condition. Therefore, each member is not disassembled during packing and transporting. The name of the outer lip 11c means it elastically contacts with the slinger 12 from outside.

In the above-mentioned assembled condition, a labyrinth r is formed between the base portion 11e of the inside axial lip 11a and the outer peripheral surface of the fitting cylindrical portion 12a of the slinger 12 in such a manner that they come close while keeping a substantially constant small gap extending the length area L along the axial direction. The labyrinth r is preferably from 0.1 mm to 0.4 mm. If it is less than 0.1 mm, the base portion 11e and the outer peripheral surface of the fitting cylindrical portion 12a might come into contact on account of the design tolerance. If it exceeds 0.4 mm, the sealing ability tends to be deteriorated. The length area L is preferably from ⅓ to ⅔ of the axial length LO of the outer peripheral surface portion of the fitting cylindrical portion 12a. If it is less than ⅓, the sealing ability might be deteriorated. If it is over ⅔, the axial lip 11a becomes short, thereby having poor soft elasticity.

The core member 10 or the slinger 12 is obtained by sheet metal processing of the cold rolled steel sheet such as SPCC into the form shown in the figure. The elastic seal member 11 is made of a rubber material selected from NBR, H-NBR, ACM, AEM, FKM and the like.

As mentioned above, the slinger 12 and the elastic seal member 11/the core member 10 are assembled to construct a pack-seal type seal ring (sealing device) 9. The seal ring 9 is fitted under pressure in between the inner ring 3 and the outer ring 6 of the bearing unit 2, and seals the sealed portion S charged with lubricant like grease together with the seal ring 8 provided at the tire wheel. In case of such fitting under pressure, the slinger 12 is externally fitted and fixed in the inner ring 3 being a rotatable member with the fitting cylindrical portion 12a. The core member 10 is internally fitted and fixed in the outer ring 6 being the stationary member by means of the fitting cylindrical portion 10a together with the elastic seal member 11. The rubber wraparound portion 11d is compressed and elastically deformed to be airtightly fitted in the outer ring 6. The dotted lines in FIG. 2 show an initial condition wherein the axial lips 11a, 11b, the outer lip 11c and the rubber wraparound portion 11d are not elastically deformed. It goes without saying that the same structure can be applied to the seal ring 8 at the tire wheel.

According to the seal ring 9 fitted in under pressure between the inner ring 3 and the outer ring 6, the slinger 12 is rotated while the inner ring 3 is axially rotated. Accompanied with the rotation of the slinger 12, the axial lips 11a, 11b and the outer lip 11c of the elastic seal member 11 come into sliding contact with the inner surface of the flange portion 12b of the slinger 12 and the outer surface of the tapered portion 12c elastically and relatively. Therefore, because of the elastic sliding contact of the outer lip 11c into the outer surface of the tapered portion 12c, waste water and dust from outside are prevented from entering into a pack space (space surrounded with the slinger and the elastic seal member 11/the core member 10) S1 at the inlet, so that dust is not involved in the space, and the axial lips 11a, 11b are not worn away, thereby achieving long life of the seal ring 9. The pack space S1 is a completely closed space, and further the outer lip 11c has superior sealing ability because it elastically and slidably contacts with the tapered portion 12c, therefore, it can effectively prevent incursion of dust from outside.

The radial lip which has been used for a sealing device as shown in the prior arts is not used, so that a large running torque cannot be applied by the elastic sliding contact of the radial lip.

While the slinger 12 is rotating, the labyrinth r is kept in the length area L in the axial direction between the base portion 11e of the axial lip 11a and the outer peripheral portion of the fitting cylindrical portion 12a of the slinger 12. Accordingly, the lubricant charged in the sealed portion S does not leak out of the small spaced labyrinth r and the rolling elements 7 are kept rolling smoothly. Provided that a part of lubricant is exuded into the labyrinth r, it is hardly exuded further because the length area L is secured. Even if it is further exuded, such exudate is completely prevented at the elastic sliding contact portion of the axial lips 11a, 11b. It is preferable that the lubricant is exuded into the elastic sliding contact portion of the axial lips 11a, 11b, because the smoothness of elastic sliding contact can be achieved. Therefore, the labyrinth r is designed taking it into consideration if necessary. FIG. 3 of the prior art JP-A-2005-524807 shows an embodiment in which a labyrinth is formed between the seal member and the slinger. However, the labyrinth is provided at the base portion of the radial lip, so that enough length area in the axial direction of the labyrinth cannot be obtained and the running torque might be enlarged because of the radial lip.

In the above-mentioned embodiment, the inner ring 3 is explained as a rotatable member and the outer ring 6 is as a stationary member, however, they may be altered each other. In such a case, the directions of the outward flange portion 12b of the slinger 12 and the inward flange portion 10b of the core member 10 are reversed respectively, and accordingly it is a matter of course that the tapered surface is gradually contracted into the sealed portion S and other member are differently shaped. Further, the above-mentioned embodiment is used for a bearing unit for supporting the tire wheel into the driving shaft of vehicle, however, it can be used for other mechanism which requires sealing. Still further, a multi-pole magnet formed with plural N-poles and S-poles in the peripheral direction is attached to the slinger 12 to form a tone wheel, and a magnetic sensor is provided so as to face the tone wheel, thereby enabling to construct a magnetic encoder for detecting rotational speed.

Although only preferable embodiments of the present invention have been disclosed and described, it is apparent that other embodiments and modification of the invention are possible.

1. A sealing device for sealing a space between two members relatively rotating in concentricity, comprising:
a slinger fixedly fitted into one of said members,
a core member fixedly fitted into the other of said members, and an elastic seal member attached to said core member, said elastic seal member having a seal lip elastically and slidably contacting with said slinger, wherein
said slinger has a fitting cylindrical portion to be fitted into said one member and a flange portion extending from said fitting cylindrical portion in its radial direction, whereas said seal lip has a base portion fixed to said core member and constitutes an axial lip elastically and slidably contacting with the inner surface of said flange portion of said slinger; and wherein
the peripheral surface of said fitting cylindrical portion of said slinger and the corresponding peripheral surface of said base portion of said elastic seal member closely face each other with substantially constant space along the axial direction of said slinger, thereby constituting labyrinth construction between them.

2. The sealing device as set forth in claim 1, wherein said seal lip is comprised of plural axial lips arranged in a radial direction and wherein said labyrinth construction is constituted by one of said axial lips provided more closely to said fitting cylindrical portion of said slinger.

3. The sealing device as set forth in claim 1, wherein the peripheral edge of said flange portion of said slinger is bended toward said fitting cylindrical portion side to constitute a tapered peripheral portion and wherein an outer lip is further provided at said elastic seal member so as to elastically and slidably contact with the outer surface of said tapered peripheral portion.

4. The sealing device as set forth in claim 1, wherein said one member is a rotating member whereas said other member is a stationary member.

5. The sealing device as set forth in claim 2, wherein the peripheral edge of said flange portion of said slinger is bended toward said fitting cylindrical portion side to constitute a taperd peripheral portion and wherein an outer lip is further provided at said elastic seal member so as to elastically and slidably contact with the outer surface of said tapered peripheral portion.

6. The sealing device as set forth in claim 3, wherein said one member is a rotating member whereas said other member is a stationary member.

7. The sealing device as set forth in claim 5, wherein said one member is a rotating member whereas said other member is a stationary member.
